(19) United States
(12) Patent Application Publication
(10) Pub. No.: US 2009/0080624 A1
(43) Pub. Date: Mar. 26, 2009

(54) System and Method for Rules-Based Caller ID Notification

(75) Inventors: David Small, Dublin, CA (US); Nalesh Chandra, Lincoln, CA (US)

Correspondence Address: AT&T Legal Department, Attn: Patent Docketing, Attn: Patent Docketing Room 2A- 207, One AT & T Way, Bedminster, NJ, 07921, US

(73) Assignee: AT&T KNOWLEDGE VENTURES, LP, Reno, NV (US)

(21) Appl. No.: 11/859,330

(22) Filed: Sep. 21, 2007

(51) Int. Cl. H04M 1/57

(52) U.S. Cl. 379/88.21; 379/142.06; 455/415

(57) ABSTRACT

A method for caller identification notification, including determining caller identification information associated with a telephone call to a first device. The method further includes sending a notification to a second device when the caller identification information matches a user defined list of caller identification information.

### FIELD OF THE DISCLOSURE

The present disclosure generally relates to caller identification, and more particularly relates to rules-based caller identification notification.

### BACKGROUND

Caller Identification (CID) information provides telephone call recipients with information about incoming calls, such as the number and name of the calling party. The CID information can be displayed on the telephone, on a stand-alone CID device, or in certain circumstances on a television. The called party can use this information to screen incoming telephone calls or to return missed calls.

### BRIEF DESCRIPTION OF THE DRAWINGS

It will be appreciated that for simplicity and clarity of illustration, elements illustrated in the Figures have not necessarily been drawn to scale. For example, the dimensions of some of the elements may be exaggerated relative to other elements. Embodiments incorporating teachings of the present disclosure are shown and described with respect to the drawings presented herein, in which:

FIG. 1 is a block diagram illustrating an embodiment of an Internet protocol television (IPTV) system;

FIG. 2 is a block diagram illustrating an embodiment of a CID notification device with IP accessibility;

FIG. 3 is a flow diagram illustrating a method of sending a notification for an incoming telephone call;

FIG. 4 is a flow diagram illustrating a method of sending a notification for an incoming telephone call with a matching status;

FIG. 5 is a state diagram illustrating a method of periodically sending a CID log; and

FIG. 6 is a flow diagram illustrating a method of sending a notification when the CID information matches a user defined rule.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

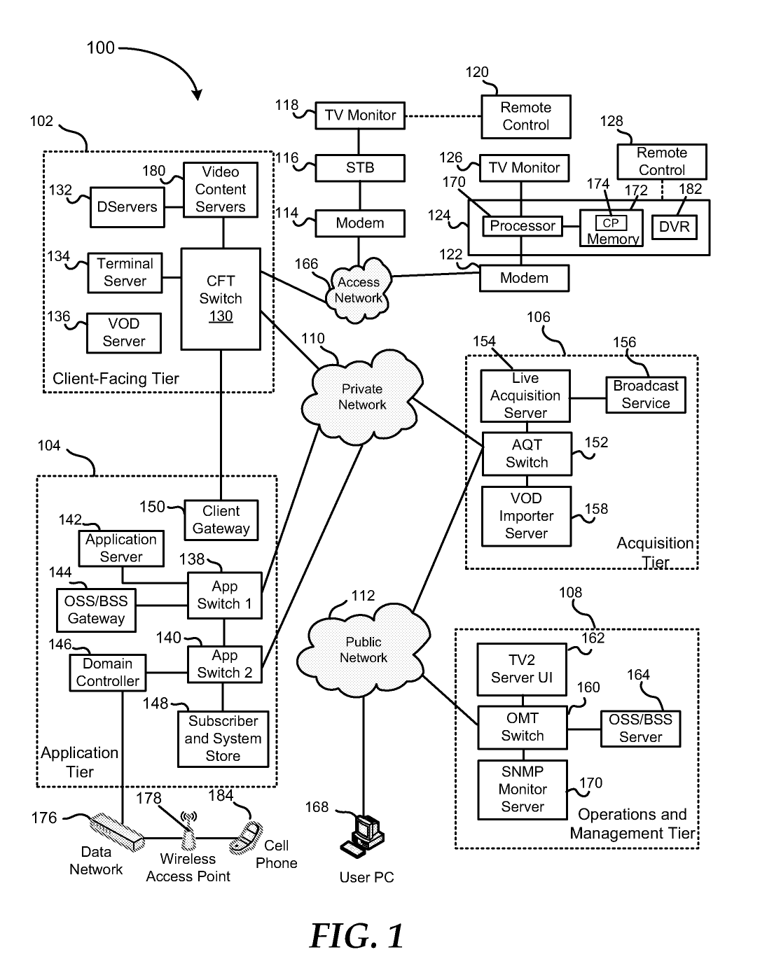

FIG. 1 shows an IPTV system 100 that can include a client facing tier 102, an application tier 104, an acquisition tier 106, and an operations and management tier 108. Each tier 102, 104, 106, and 108 is coupled to a private network 110, a public network 112, or both the private network 110 and the public network 112. For example, the client-facing tier 102 can be coupled to the private network 110. Further, the application tier 104 can be coupled to the private network 110 and to the public network 112, such as the Internet. The acquisition tier 106 can also be coupled to the private network 110 and to the public network 112. Moreover, the operations and management tier 108 can be coupled to the public network 112.

The various tiers 102, 104, 106, and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device (STB) 116 via the first modem 114 and with a second representative set-top box device 124 via the second modem 122. The client-facing tier 102 can communicate with a large number of set-top boxes, such as the representative set-top boxes 116 and 124, over a wide geographic area, such as a regional area, a metropolitan area, a viewing area, or any other suitable geographic area that can be supported by networking the client-facing tier 102 to numerous set-top box devices. In an illustrative embodiment, the client facing tier or any portion thereof can be included at a video head-end office.

In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received through the private access network 166 via an IPTV software platform such as Microsoft® TV IPTV Edition.

Additionally, the first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display devices 118 and 126 to which it is coupled. In an illustrative embodiment, the set-top box devices 116 and 124 can include tuners that receive and decode television programming information for transmission to the display devices 118 and 126. The television tuner can be National Television System Committee (NTSC) tuner, an Advanced Television System Committee (ATSC), another suitable analog or digital tuner, or any combination thereof. A signal for a television channel can pass through the tuner before the content is displayed on a monitor.

In an exemplary, non-limiting embodiment, STB devices 116 and 124 can receive video content, which may include video and audio portions, from the client-facing tier 102 via the private access network 166. The STB device 116 and 124 can transmit the video content to an external display device, such as the television monitors 118 and 126. The STB devices 116 and 124 can also communicate commands received from the remote control devices 120 and 128 to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server 168 and other devices with a common connection point to the private network 110. In a particular embodiment, the CFT switch 130 can also be coupled to a video-on-demand (VOD) server 136 that stores or provides VOD content imported by the IPTV system 100. The client-facing tier 102 can also include one or more video content servers 180 that transmit video content requested by viewers via their STB devices 116 and 124. In an illustrative, non-limiting embodiment, the video content servers 180 can include one or more multicast servers.

As shown in FIG. 1, the application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions, such as display, messaging, processing of IPTV data and VOD material, etc. In a particular embodiment, the OSS/BSS gateway 144 includes operation systems and support (OSS) data, as well as billing systems and support (BSS) data.

Further, the second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166, using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when a set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138 to the second APP switch 140, and the second APP switch 140 can communicate the query across the public network 112 to an OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, for example because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment during operation of the IPTV system, the live acquisition server 154 can acquire television or movie content. The live acquisition server 154 can transmit the television or movie content to the AQT switch 152, and the AQT switch can transmit the television or movie content to the CFT switch 130 via the private network 110.

Further, the television or movie content can be transmitted to the video content servers 180, where it can be encoded, formatted, stored, or otherwise manipulated and prepared for communication to the STB devices 116 and 124. The CFT switch 130 can communicate the television or movie content to the modems 114 and 122 via the private access network 166. The STB devices 116 and 124 can receive the television or movie content via the modems 114 and 122, and can transmit the television or movie content to the television monitors 118 and 126. In an illustrative embodiment, video or audio portions of the television or movie content can be streamed to the STB devices 116 and 124.

Further, the AQT switch can be coupled to a VOD importer server 158 that stores television or movie content received at the acquisition tier 106 and communicates the stored content to the VOD server 136 at the client-facing tier 102 via the private network 110. Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the STB devices 116 and 124, the requests can be transmitted over the private access network 166 to the VOD server 136 via the CFT switch 130. Upon receiving such requests, the VOD server 136 can retrieve the requested VOD content and transmit the content to the STB devices 116 and 124 across the private access network 166 via the CFT switch 130. The STB devices 116 and 124 can transmit the VOD content to the television monitors 118 and 126. In an illustrative embodiment, video or audio portions of VOD content can be streamed to the STB devices 116 and 124.

The operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to the OSS/BSS server 164 and to a simple network management protocol (SNMP) monitor 170 that monitors network devices within or coupled to the IPTV system 100. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 can transmit the television or movie content to the AQT switch 152, and the AQT switch 152 in turn can transmit the television content to the CFT switch 130 via the private network 110 or to the OMT switch 160 via the public network 112. Further, the television content can be encoded at the D-servers 132, and the CFT switch 130 can communicate the television content to the modems 114 and, 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to set-top box devices 116 and 124, the request can be transmitted over the private access network 166 to the VOD server 136 via the CFT switch 130. Upon receiving such a request, the VOD server 136 can retrieve requested VOD content and transmit the content to the set-top box devices 116 and 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer 168 coupled to the public network 112.

The domain controller 146 communicates with the public network 112 via the second APP switch 140. Additionally, the domain controller 146 can communicate via the public network 112 with the personal computer 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices, such as a cellular telephone 184.

In a particular embodiment, a set-top box device such as the second set-top box device 124 can include an STB processor 170 and an STB memory device 172 that is accessible to the STB processor 170. The set-top box device 124 also includes an STB computer program 174 that is embedded within the STB memory device 172. In a particular embodiment, the STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124, by associating the user account with an IP address of the second set-top box device with data relating to one or more twisted pairs connected with the second set-top box device 124, with data related to one or more fiber optic cables connected with the second set-top box device 124, with an alphanumeric identifier of the second set-top box device 124, with any other data that is suitable for associating second set-top box device 124 with a user account, or with any combination of these.

The STB computer program 174 can contain instructions to receive many types of user preferences from the domain controller 146 via the access network 166. For example, the STB computer program 174 can include instructions to receive a request to record at least one television program at a video content storage module such as a digital video recorder (DVR) 182 within the second set-top box device 124. In this example embodiment, the STB computer program 174 can include instructions to transmit the request to the DVR 182, where the television program(s) are recorded. In an illustrative embodiment, the STB computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP). Further details of the IPTV system are taught in U.S. Patent Application Publication No. 2007/0199041, the disclosure of which is hereby incorporated by reference.

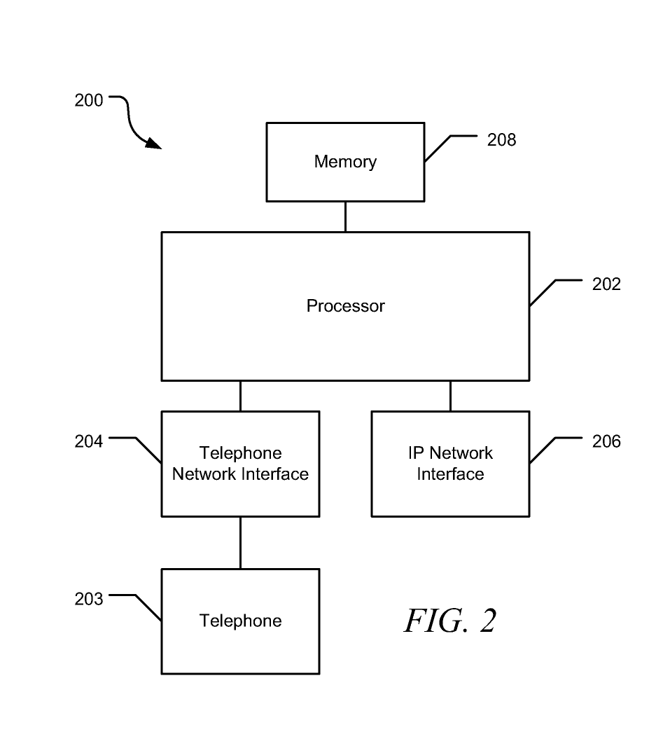

FIG. 2 shows a CID notification device 200 that may be customer premise equipment such as a residential DSL gateway, the IPTV set top box 124, a telephone, or a separate CID device. In an alternative embodiment, the CID notification device 200 can be network operator equipment located somewhere other than the customer location. The device 200 can have a processor 202, a telephone network interface 204, an IP network interface 206, and a memory 208. In an exemplary embodiment, the telephone network and the IP network may be modulated on the same physical layer, such as a coax cable, a twisted pair, a fiber optic cable, or a wireless link. In such an embodiment, the telephone network interface 204 and the IP network interface 206 can share the same connector. In an alternate embodiment, the IP network interface 206 may connect to a different physical layer from the telephone network interface 204. For example, the IP network interface may connect to a wireless link and the telephone network interface may connect to a twisted pair. In yet another embodiment, the CID notification device may connect to a voice-over-IP (VOIP) network and the telephone network interface 204 and the IP network interface 206 may be the same network interface.

The processor 202 can detect incoming calls to a telephone 203 on the telephone network interface 204, and log the CID information in the memory 208. The CID information can include either the telephone number of the calling party, the name of the calling party, or both. In an exemplary embodiment, the processor may send a notification through the IP network after the incoming telephone call is terminated. The notification may be a text page sent to a pager, an SMS text message sent to a cell phone, an email sent to a computer or a cell phone, a voice notification such as a phone call to a designated phone number, a facsimile, a web-posting, or a message to the IPTV monitor 118 or 126. The notification may include the CID information and the time of the call.

In an alternate embodiment, the processor 202 can determine the status of the incoming telephone call. An answered call may be an incoming telephone call that is picked up. An unanswered call may be an incoming telephone call that is transferred to voice mail. An abandoned call may be an incoming telephone call that is terminated prior to being picked up or transferred to voice mail. The processor 202 may send a notification when the status of the incoming telephone call matches a defined status. For example, the processor 202 may send a notification after each abandoned call. Additionally, the processor 202 may send a notification after each incoming telephone call with a status of unanswered. The notification may further include the status of the incoming telephone call.

In another embodiment, the processor 202 can compare the CID information against a rule stored in the memory and send a notification through the IP network interface 206. In a further embodiment, the processor may send a periodic notification. For example, the notification may be sent after an amount of time has passed or after a predetermined number of calls have been received. A periodic notification may include the CID information for a number of calls stored in the memory 208. The periodic notification may also include the time and the status of each of the incoming telephone calls.

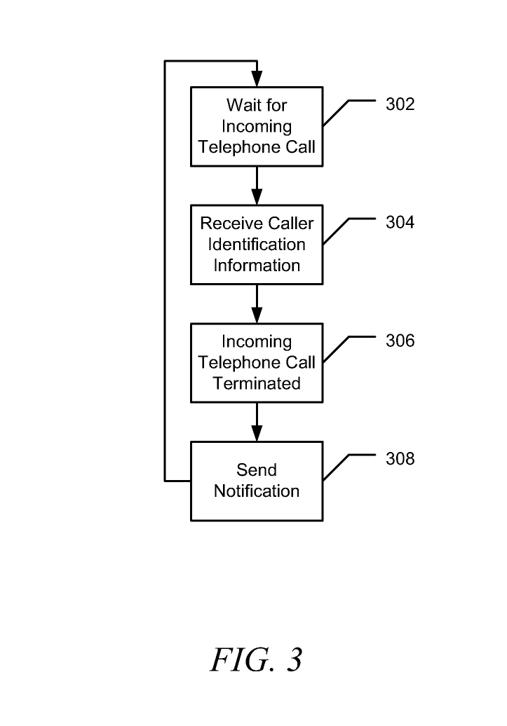

FIG. 3 illustrates an exemplary method of sending a notification for an incoming telephone call. As illustrated at 302, a CID notification device can wait for an incoming telephone call. The CID notification device may receive the CID information at 304. The incoming telephone call can be terminated at 306. The CID notification device can send a notification, as illustrated at 308, and the CID notification device may return to 302 to wait for the next incoming telephone call.

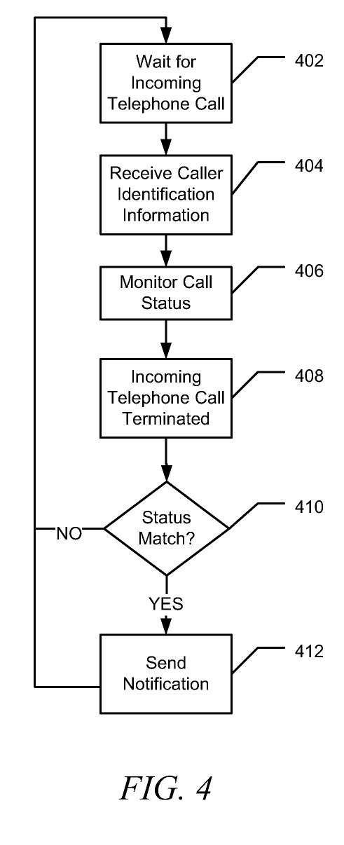

FIG. 4 illustrates an exemplary method of sending a notification for an abandoned incoming telephone call. As illustrated at 402, a CID notification device can wait for an incoming telephone call. The CID notification device may receive the CID information at 404. The CID notification device can monitor the status of the incoming telephone call, as illustrated at 406. The incoming telephone call can be terminated at 408. Illustrated at 410, the CID notification device can determine if the status of the incoming telephone call matches a user defined rule. When the status of the incoming telephone call matches the user defined rule, the CID notification device may send a notification, as illustrated at 412, and return to 402 to wait for an incoming telephone call. For example, the CID notification device may send a notification when a call is unanswered or abandoned. Alternatively, when the status of the incoming telephone call does not match the user defined rule, the CID notification device may return to 402 to wait for an incoming telephone call.

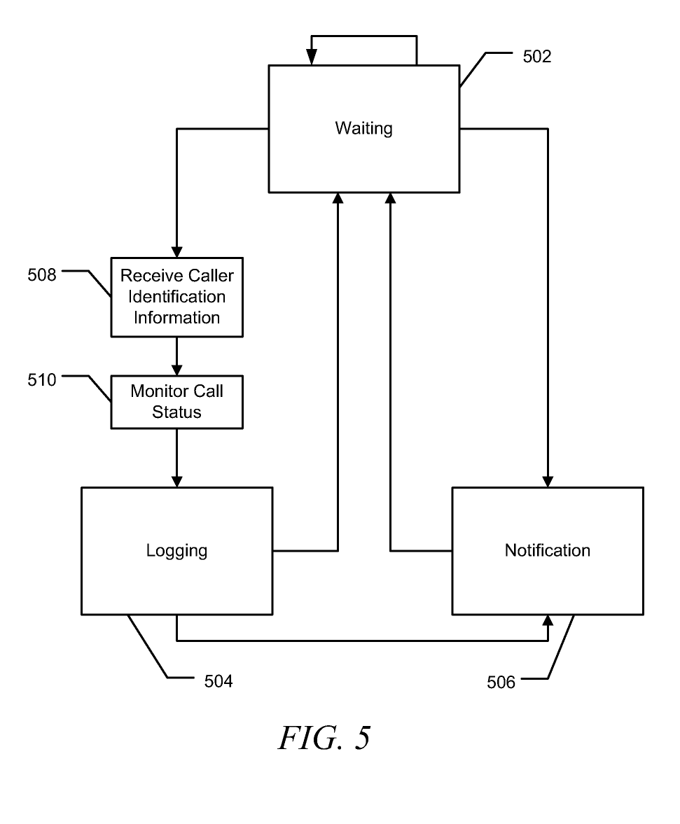

FIG. 5 illustrates an exemplary state diagram for sending periodic notifications of incoming telephone calls. The CID notification device can have three states, a waiting state 502, a logging state 504, and a notification state 506. Starting at the waiting state 502, the CID notification device detects an incoming call and transitions to the logging state 504. In the process, the CID notification device can receive CID information at 508 and monitor the status of the incoming telephone call at 510. Once in the logging state 504, the CID notification device can add the CID information to a log of incoming CID information. Additionally, the CID notification device may add the status to the log of incoming CID information. When a number of incoming telephone calls have been received or a user defined period of time has passed since the last notification, the CID notification device may transition to the notification state 506. In the notification state 506, the CID notification device may send a periodic notification, including a log of all the incoming telephone calls received since the last periodic notification. For example, the periodic notification may include all the calls received over a period of time. Additionally, the periodic notification can include the time and status of each incoming telephone call. Alternatively, the periodic notification may include only the incoming telephone calls with a specified status, such as only the calls that were abandoned. Upon completion of sending the notification, the CID notification device returned to the waiting state 502. From the waiting state 502, the CID notification device can transition to the logging state 504 when another incoming telephone call is received. Alternatively, the CID notification device may transition directly to the notification state 506, such as when a user defined period of time has elapsed since the last periodic notification.

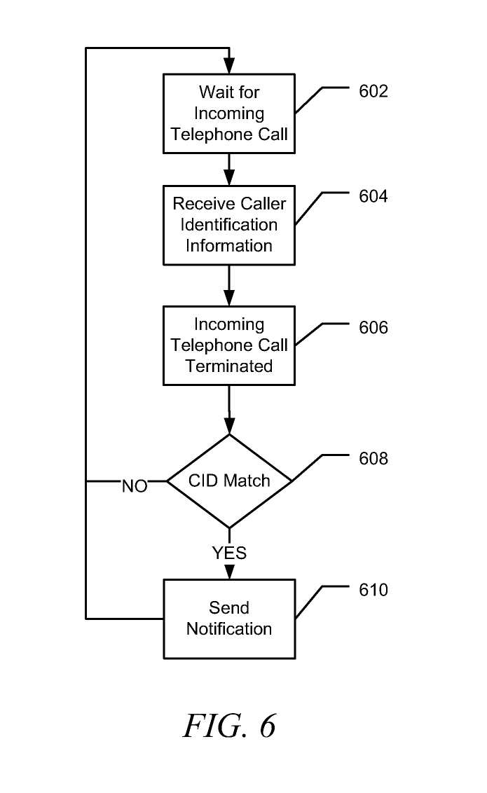

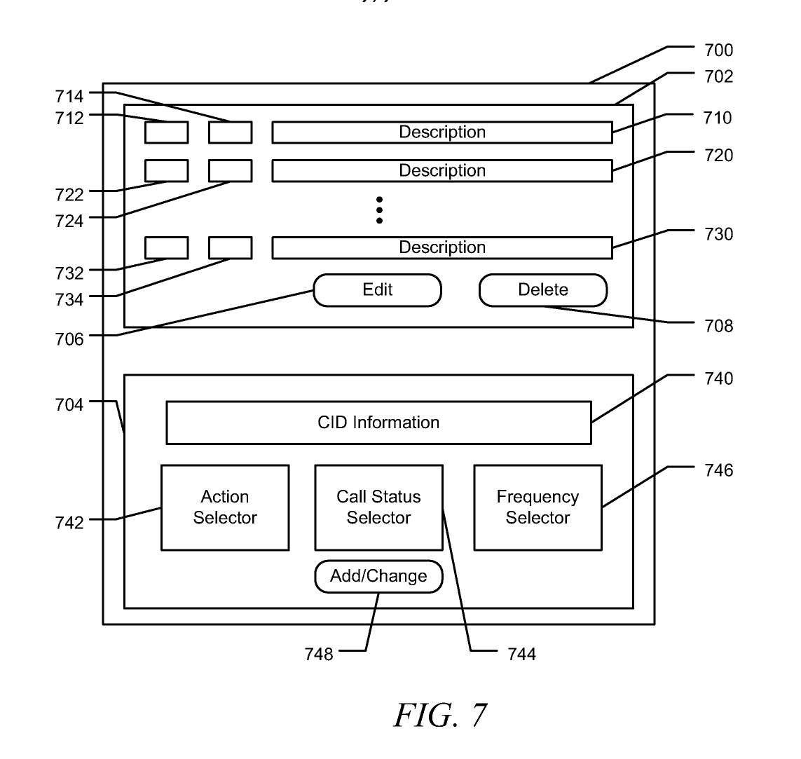

FIG. 6 is an illustration of an exemplary method of sending a notification when an incoming telephone call matches a user defined rule. The CID notification device can wait for an incoming telephone call, as illustrated at 602. The CID notification device may receive the CID information, as illustrated at 604. At 606, the incoming telephone call may be terminated. The CID notification device compares the CID information to the user defined rule, as illustrated at 608. When the CID information matches the user defined rule, the CID notification device can send a notification, as illustrated at 610, and the CID notification device may return to step 602 to wait for an incoming telephone call. Alternatively, when the CID information does not match the user defined rule, the CID may return to step 602 to wait for an incoming telephone call. In an alternate embodiment, a user defined list, such as a black list, may identify incoming telephone calls for which no notification is sent. For example, the CID notification device may send a notification for all calls except those on the user defined black list. Additionally, incoming telephone calls on the black list may be excluded from periodic notifications or the CID log.

FIG. 7 is a block diagram illustrating an exemplary interface 700 for configuring the CID notification device. The interface may be a web page when configuring a web configurable device, such as a DSL residential gateway. Alternatively, the interface may be provided on a television when configuring a device connected to a television, such an STB. The interface 700 may include a list pane 702 and an edit pane 704. The list pane 702 can allow for viewing, selection, and removal of configured rules. The edit pane 704 can allow for adding new rules or editing existing rules.

The list panel 702 may include an edit button 706 and a delete button 708. The edit button 706 may allow editing of a selected rule. Activating the edit button 706 may populate the edit pane 704 with information regarding the selected rule. The delete button 708 may allow removal of a selected rule. Activating the delete button 708 may update the list pane 702 to indicate the selected rule has been removed. The list panel 702 may also provide a description 710, 720, 730 for configured rules. Additionally, the list panel 702 may include a selection indicator 712, 722, 732. The selection indicator 712, 722, 732 can be used to select a rule for editing or deleting. The selection indicator 712, 722, 732 can be a selection element such as a checkbox or a radio button. Further, the list panel 702 may include an enabled indicator 714, 724, 734. The enabled indicator 714, 724, 734 may be used to configure a corresponding rule to be enabled or disabled. The enabled indicator 714, 724, 734 can be a selection element such as a checkbox or a radio button.

The edit pane 704 can allow changing of a selected rule, such as when the edit button 706 is activated, or the addition of new rules. The edit pane 704 can include a CID information entry 740, an action selector 742, a call status selector 744, a frequency selector 746, and an add/change button 748. The add/change button 748 can be used to save rule changes and update the list pane, such as after a selected rule is edited or a new rule is added.

The CID information entry 740 can allow the entry of CID information to indicate incoming telephone calls to which the rule applies. The CID information entry 740 may be a text field where the number or name associated with an incoming telephone call can be entered. Alternatively, the CID information may be entered by selecting the CID information from a previous incoming telephone call, such as selecting the CID information from the CID log. The CID information entry 740 may be left blank to indicate the rule applies to all incoming telephone calls.

The action selector 742 may allow for selecting an action, such as sending a notification, or not sending a notification. Additionally, the action selector 742 may allow for configuring the notification, such as entering an email address or telephone number for sending the notification. The call status selector 744 may allow for selecting one or more call status types, such as answered, unanswered or abandoned. Selection of one or more call status types can indicate incoming telephone calls to which the rule applies. For example, a rule for notification of each incoming telephone call that is abandoned would have only the abandoned call status type selected.

The frequency selector 746 can allow the selection of a frequency for sending the notification. The frequency selector 746 may be used to select a number of matching incoming telephone calls prior to sending a notification, such as after every matching incoming telephone call or after five matching incoming telephone calls. Additionally, the frequency selector 746 may be used to select a period of time prior to sending a notification, such as every one day or every six hours.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method for caller identification notification, comprising:
determining caller identification information associated with a telephone call to a first device; and
sending a notification to a second device when the caller identification information matches a user defined list of caller identification information.

2. The method of claim 1 wherein the notification includes the caller identification information.

3. The method of claim 1 wherein the second device is a mobile device.

4. The method of claim 1 wherein the caller identification information comprises a telephone number.

5. The method of claim 1 wherein the caller identification information comprises a name.

6. The method of claim 1 wherein sending the notification includes sending at least one of a page, an email, a SMS text message, an audio message or any combination thereof.

7. The method of claim 1 further comprising providing an interface to update the user defined list of called identification information.

8. The method of claim 7 wherein the interface includes a web page.

9. The method of claim 1 further comprising storing the caller identification information into a caller identification log.

10. A method of caller identification, comprising:
determining caller identification information associated with an unanswered or an abandoned telephone call to a first device; and
sending the caller identification information to a second device after the telephone call terminates.

11. The method of claim 10 wherein the second device is a mobile device.

12. The method of claim 10 wherein the caller identification information comprises a telephone number.

13. The method of claim 10 wherein the caller identification information is sent at a predetermined time.

14. The method of claim 10 wherein the caller identification information is sent when the caller identification information matches predefined caller identification information.

15. The method of claim 10 wherein the caller identification information is sent as part of a log.

16. The method of claim 10 wherein sending the notification includes sending at least one of a page, an email, a SMS text message, an audio message or any combination thereof.

17. The method of claim 10 further comprising providing an interface to update the user defined list of called identification information and configure the notification.

18. A method for caller identification notification, comprising:
determining call information associated with a telephone call to a first device; and
sending a notification to a second device when the call information matches a user defined rule set.

19. The method of claim 18 wherein the call information includes caller identification information.

20. The method of claim 19 wherein the caller identification information comprises a telephone number.

21. The method of claim 18 wherein the notification includes the call information.

22. The method of claim 18 wherein the second device is a mobile device.

23. The method of claim 18 wherein sending the notification includes sending at least one of a page, an email, a SMS text message, an audio message, a facsimile, or any combination thereof.

24. The method of claim 18 further comprising providing an interface to update the user defined list of called identification information.
